(19) United States
(12) Patent Application Publication
(10) Pub. No.: US 2026/0039627 A1
(43) Pub. Date: Feb. 5, 2026

(54) AUTOMATIC DISCOVERY OF APPLICATION ADMINISTRATOR

(71) Applicant: Palo Alto Networks, Inc., Santa Clara, CA (US)

(72) Inventors: Charles Clement Gomes, Dublin, CA (US); Chandan Sajjan Agarwal, Sunnyvale, CA (US); Sreejith Rajkumar, Danville, CA (US); Anurag Mukund Phadke, Sunnyvale, CA (US); Chintan Ranjitkumar Desai, Fremont, CA (US)

(21) Appl. No.: 18/789,388

(22) Filed: Jul. 30, 2024

(51) Int. Cl. H04L 9/40; H04L 41/16

(52) U.S. Cl. CPC H04L 63/0236; H04L 41/16; H04L 63/20

(57) ABSTRACT

Various techniques for providing automatic discovery of application administrator are disclosed. In some embodiments, a system, a process, and/or a computer program product for automatic discovery of application administrator includes automatically determining an administrator for an application (e.g., a Software as a Service (SaaS) application) associated with an organization by processing logs (e.g., firewall logs) for Uniform Resource Locators (URLs) visited by a user; matching the URLs for patterns that the administrator of that application visits using a machine learning (ML) model or based on known URL patterns; and sending the determined administrator for the application associated with the organization to an external service.

### BACKGROUND OF THE INVENTION

A firewall generally protects networks from unauthorized access while permitting authorized communications to pass through the firewall. A firewall is typically a device or a set of devices, or software executed on a device, such as a computer, which provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRAWINGS

Various embodiments of the invention are disclosed in the following detailed description and the accompanying drawings.

FIG. 1 illustrates an overall system architecture for providing automatic discovery of application administrator in accordance with some embodiments.

FIG. 2 illustrates a screen diagram of a system for providing the automatic discovery of application administrator solution in accordance with some embodiments.

FIG. 3 is a flow diagram for a process for providing automatic discovery of application administrator in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls).

For example, Palo Alto Networks' next generation firewalls enable enterprises and service providers to identify and control applications, users, and content—not just ports, IP addresses, and packets—using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

Security service providers also offer various commercially available cloud-based security solutions including various firewall and VPN, including Secure Access Service Edge (SASE), and various other security related services. For example, some security service providers have their own data centers in multiple geographies across the world to provide their customers such cloud-based security solutions.

Generally, a secure access service edge (SASE) brings together networking and network security services in a single cloud-based platform. This way, organizations can embrace cloud and mobility while reducing the complexity of dealing with multiple point products as well as saving IT, financial, and human resources.

For example, a SASE solution can generally include networking capabilities that an enterprise already uses. SASE can integrate the following networking features into a cloud-based infrastructure: SD-WAN edge devices, VPN services, and web proxying, which are each further described below.

Software-defined wide area network (SD-WAN) edge devices can provide easier connectivity for branch offices. With SASE, these devices are connected to a cloud-based infrastructure rather than to physical SD-WAN hubs located in other locations. By moving to the cloud, enterprises can eliminate the complexity of managing physical SD-WAN hubs and promote interconnectivity between branch offices.

Virtual private network (VPN) services incorporated by a SASE solution enable enterprises to route traffic through a VPN (e.g., using IPSec tunnels) to the SASE solution, and then to any application in the public or private cloud, delivered via Software as a Service (SaaS), or on the Internet. Traditional VPN was used for remote access to the internal data center, but it is typically not optimized for the current/evolving cloud computing environment.

Web proxying provides an alternate means of securely connecting users to applications by inspecting web-based protocols and traffic. Proxies were typically used for web security enforcement, but due to their inherent security limitations, they are now typically used as an architectural alternative for device traffic that cannot be fully inspected (e.g., personal devices that cannot accept an endpoint agent to force all web and non-web traffic through security inspection). When implemented as part of a SASE solution, proxies can offer organizations with legacy architectures an easier way of adopting the more robust security capabilities SASE has to offer.

In addition, SASE can incorporate the network security service tools enterprises have generally relied upon in prior computing environments. In a comprehensive SASE solution, the following security services can be delivered through a cloud-based infrastructure: zero trust network access (ZTNA), firewall/security as a service (FWaaS), secure web gateways (SWG), data loss prevention (DLP), and cloud access security broker (CASB), which are each further described below.

Zero Trust Network Access (ZTNA) applies the Zero Trust secure computing approach (e.g., never trust, always verify) to the cloud computing environment. For example, ZTNA can be applied to require that every user authenticate to access the cloud, restricting access and minimizing the risk of, for example, data loss. However, ZTNA solutions based on a software-defined perimeter (SDP) model can lack content inspection capabilities needed for consistent security protection for enterprises. Also, moving to a cloud-based SASE infrastructure can eliminate the complexity of connecting to a gateway. For example, users, devices, and apps can be identified no matter where they connect from, and the below further described ZTNA solutions of protecting applications can be applied across all services, including data loss prevention (DLP) and threat prevention.

Firewall as a service (FWaaS) provides next-generation firewall features in the cloud computing environment (e.g., also referred to herein as the cloud), thereby removing the need for physical hardware at branch and retail locations. For example, SASE solutions can integrate FWaaS into its cloud-based platform, allowing simplified management and deployment.

### Overview of Techniques for Providing Automatic Discovery of Application Administrator

However, there exists technical challenges in setting up and managing security policy enforcement for organizations (e.g., enterprises, government entities, and/or other entities) that typically utilize various applications. For example, in a typical organization, there are on average about 150 or more applications, which is excluding unsanctioned applications.

As such, in an organization, when setting up and enforcing information security practices, information security/technology administrators find it difficult to know which user(s) in their organization are an administrator (admin) for a given application (e.g., Software as a Service (SaaS) applications and/or other applications (apps)) used in their organization.

This information is often either tribal knowledge or is documented somewhere in the organization which the information security administrator does not have direct visibility into or is needed to be maintained and managed by the organization. This information about administrators can become obsolete and is not necessarily explicitly updated for apps. It typically requires approximately one day to two weeks to find the administrator for a given app (e.g., an example customer needed six weeks to determine the correct admin user for one of their SaaS apps, to identify their correct ServiceNow admin user).

As such, new and improved solutions are needed for setting up and enforcing information security practices, such as for enterprises and/or other entities.

An example SaaS catalog has more than 50,000 applications. Based on our observations, thousands of SaaS applications are often discovered for an existing tenant (e.g., a tenant of security service offerings, such as a SaaS security solution, provided by Palo Alto Networks, Inc., headquartered in Santa Clara, CA).

As such, this reveals the technical complexity associated with attempting to address the above-described problems with onboarding of applications for SaaS security solutions (e.g., identifying the information security/technology admins for apps can be particularly challenging in such enterprise environments as similarly described above).

Accordingly, various techniques for providing automatic discovery of application administrator are disclosed.

In some embodiments, a system, a process, and/or a computer program product for automatic discovery of application administrator includes automatically determining an administrator for an application (e.g., a Software as a Service (SaaS) application) associated with an organization by processing logs (e.g., firewall logs) for Uniform Resource Locators (URLs) (e.g., or Uniform Resource Indicators (URIs)) visited by a user; matching the URLs for patterns that an administrator of that application visits using a machine learning (ML) model or based on known URL patterns; and sending the determined administrator for the application associated with the organization to an external service.

For example, a scheduler service can be used to identify the known URL patterns based on public API documentation. In this example, the known URL patterns can also then be matched using a regular expression (regex) pattern matcher.

As another example, the external service can be a security service. In this example, the determined administrator for the application associated with the organization can be sent to the security service for onboarding the application associated with the organization for security management.

In some embodiments, the ML model includes an ML-based classifier for classifying the URLs as being associated with administrator activity for the application. For example, the ML-based classifier (e.g., using Random Forest or Support Vector Machine related machine learning techniques (MLT)) for classifying the URLs as being associated with administrator activity for the application, such as will be further described below.

In some embodiments, the ML model includes a Large Language Model (LLM) for classifying the URLs as being associated with administrator activity for the application, and further includes generating one or more prompts for LLM. For example, the ML model can be implemented using commercially available LLM solutions or transformers (e.g., using BERT, which is publicly available at https://huggingface.co/docs/transformers/en/model_doc/bert), such as will be further described below.

In some embodiments, a system, a process, and/or a computer program product for automatic discovery of application administrator further includes generating scores for each of the URLs and ranking users visiting the URLs by frequency to determine top ranked users as candidates for the administrator for the application associated with the organization.

In some embodiments, a system, a process, and/or a computer program product for automatic discovery of application administrator further includes analyzing public API documentation using the ML model to predict whether an API URL is an administrator action URL.

In some embodiments, a system, a process, and/or a computer program product for automatic discovery of application administrator further includes monitoring for any changes in updates in API documentation and/or new trends in the logs (e.g., firewall logs) for ongoing model training.

In some embodiments, a system, a process, and/or a computer program product for automatic discovery of application administrator further includes identifying one or more SaaS application administrators for the organization (e.g., and instructing the SaaS application administrators to perform one or more actions to secure their SaaS application environment).

In some embodiments, a system, a process, and/or a computer program product for automatic discovery of application administrator further includes onboarding the application in data or posture security using the external service.

In some embodiments, a system, a process, and/or a computer program product for automatic discovery of application administrator further includes performing configuration changes associated with the application for enhanced security.

In some embodiments, a system, a process, and/or a computer program product for automatic discovery of application administrator further includes viewing distinct instances of the application and identifying respective administrators.

In an example implementation, the disclosed solution for providing automatic discovery of application administrator automatically discovers an administrator(s) for a given application by processing logs (e.g., firewall logs) for an organization. Specifically, firewall logs can be automatically processed to extract URLs visited by a given user and to match the URLs for patterns that a typical administrator of that application would visit. The disclosed solution for providing automatic discovery of application administrator can then generate a score and rank users visiting this URL by frequency to identify the top ranked users as candidates for administrator users for each of the apps, such as will be further described below with respect to various embodiments.

The disclosed SaaS security solution can automatically discover (auto-discover) SaaS application administrators to ensure that an information security/technology admin can use the disclosed SaaS security solution for SaaS application inventory management for their organization.

The disclosed SaaS security solution can auto-discover SaaS application administrators to ensure that an information security/technology administrator can also use the disclosed SaaS security solution for tracking of old, new, and/or updated administrators associated with each of the apps associated with their organization.

The disclosed SaaS security solution can facilitate an information security/technology administrator to more easily identify their SaaS application administrators. For example, the information security/technology administrator can then ask the identified SaaS application administrators to perform appropriate actions to secure their SaaS environments.

The disclosed SaaS security solution can also be applied to facilitate an information security/technology administrator to more effectively and efficiently perform onboarding of the SaaS applications in data and/or posture security, to perform configuration changes, to view different instances of the application, and/or to identify respective admins.

Accordingly, SaaS apps are widely used and onboarding of SaaS apps to security platforms within a shorter period of time is a technical challenge for many organizations. There are currently more than 50,000 SaaS apps available with a new app launching every other day, including an ever increasing number of artificial intelligence (AI) related SaaS apps. For example, as will be further described below with respect to various embodiments, when enforcing information security practices, information security administrators can utilize the disclosed app admin discovery solution to more effectively and efficiently identify the list of administrators for a given app (e.g., SaaS/other app) which reduces the amount of effort and time spent to assign onboarding for an app to an app administrator. Moreover, this reduces the manual effort and time required to configure and set up the enforcement process of onboarding of such apps associated with various information security solutions (e.g., the Prisma® SASE solution, which is a commercially available security solution from Palo Alto Networks, Inc., headquartered in Santa Clara, CA). This also reduces to an extent the need for manually documenting administrators for such apps for a given organization.

Additional system embodiments and techniques for providing the automatic discovery of an application administrator solution will now be further described below.

### Example System Embodiments for Providing Automatic Discovery of Application Administrator

Example system embodiments for providing automatic discovery of application administrator solve these technical challenges as will now be further described below.

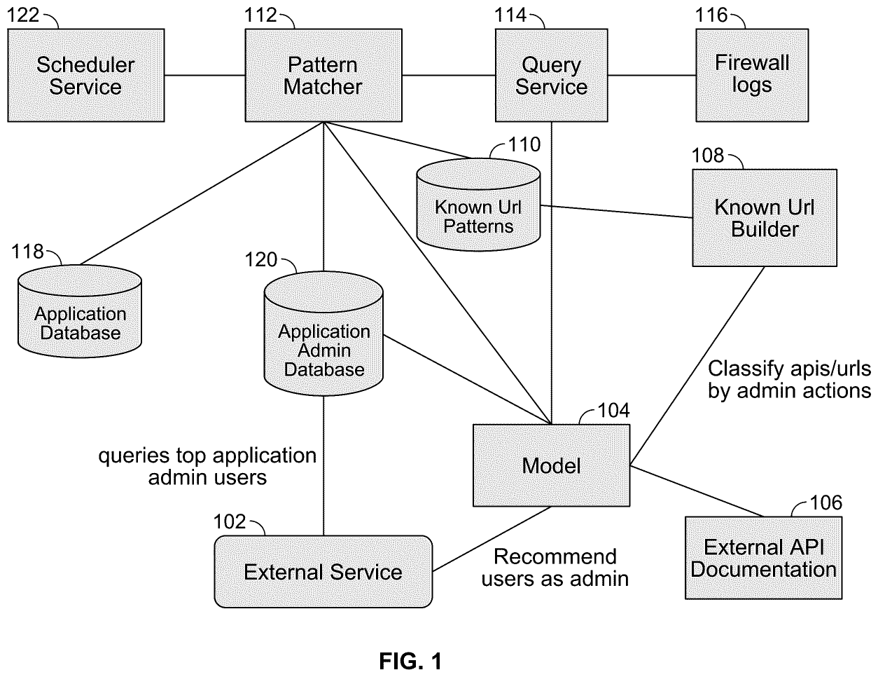

FIG. 1 illustrates an overall system architecture for providing automatic discovery of application administrator in accordance with some embodiments. Generally, the disclosed automatic discovery of the application administrator system as shown in FIG. 1 provides an example implementation of a SaaS security solution that can automatically discover (auto-discover) SaaS application administrators to ensure that an information security/technology admin can use the disclosed SaaS security solution for SaaS application inventory management for their organization.

In this example implementation, the disclosed solution for providing automatic discovery of application administrator that automatically discovers an administrator(s) for a given application is by processing logs (e.g., firewall logs) for an organization. Specifically, firewall logs can be automatically processed to extract URLs visited by a given user and to match the URLs for patterns that a typical administrator of that application would visit. The disclosed solution for providing automatic discovery of application administrator can then generate a score and rank users visiting this URL by frequency to identify the top ranked users as candidates for administrator users for each of the apps, such as will be further described below with respect to various embodiments.

In this example implementation, the system shown in FIG. 1 includes the following components: an external service 102, a model 104, external API documentation 106, a known URL builder 108, known URL patterns 110, a pattern matcher 112, a query service 114, firewall logs 116, an application database 118, an application administrator (admin) database 120, and a scheduler service 122.

Scheduler Service 122 queries firewall logs 116 using query service 114 based on discovered applications maintained in application database 118.

Known URL Builder 108 can be implemented as a service that trains a model shown at 104 (e.g., implemented as an ML-based model, such as a classifier or an LLM) based on external public API documentation available for all discovered applications to classify APIs/URLs by administrator actions.

Model 104 is trained (e.g., periodically/continuously) using query service 114 with firewall logs 116 to identify new application URLs. Specifically, the model can be periodically/continuously retrained using external API documentation 106 that has been updated or changed since the original/prior training of the model. In some embodiments, the ML model includes an ML-based classifier (e.g., using Random Forest or Support Vector Machine MLT) for classifying the URLs as being associated with administrator activity for the application, such as will be further described below. In some embodiments, the ML model includes a Large Language Model (LLM) (e.g., using OpenAI ChatGPT 4.0 or another publicly available LLM can be similarly used) for classifying the URLs as being associated with administrator activity for the application, and further includes generating one or more prompts for LLM, such as will be further described below.

Pattern matcher 112 extracts the visited URL(s) from the firewall logs 116. Pattern matcher 112 also matches the visited URLs with known administrator URL patterns 110 for that application and visited the URL that recorded the response as a success (e.g., the pattern matcher can be implemented as a regular expression (regex) pattern matcher). Based on a successful pattern match, pattern matcher 112 then increments the frequency of the number of times the user visited the administrator URL. Specifically, the regex pattern matcher can attempt to match URLs based on logged queries for URLs related to API endpoints and/or background traffic observed when an admin logs in/navigates admin features in the SaaS application (e.g., filtering out of noise by using the referrer field can also be applied to improve the efficacy of this URL pattern matching for identifying the relevant admin users of each SaaS app; and then as described herein the most relevant admins can be determined based on higher counts/most observations and, in some cases, based on last seen timestamps, etc.).

Below is an example of using the above-described URL pattern matching for identifying the relevant admin users of each SaaS app performed using Prisma SASE log data that is across multiple tenants, which illustrates example queries and results for each query.

Example Query 1 for Slack: select referer, url_domain, source_user, count(1) from ‘firewall_url’ where time_generated>‘2023 Aug. 1’ and regexp_contains(uri, ‘slack.com/api/(users.admin.fetchTeamUsers|payments.stripe.customer.get)’) group by 1,2,3

### Result: 1

Example Query 1 for Google Workspace: select referer_fqdn, url_domain, source_user, count(1) from ‘firewall_url’ where time_generated>‘2023 Aug. 1’ and uri like ‘% admin.google.com/_/%’ and http_method.value=‘post’ group by 1,2,3

### Result: 27

Example Query 1 for Office 365: select referer_fqdn, url_domain, source_user, from ‘firewall_url’ where time_generated>‘2023 Aug. 1’ and uri like count(1) ‘% admin.microsoft.com/admin/api/features/config %’ group by 1,2,3

### Result: 71

Model 104 recommends discovered administrators/change in administrators for different applications and also utilizes application administrator database 120 as an augmented knowledge base to improve the recommendations.

External service (e.g., a security service, such as Prisma® SASE or another security service) can utilize the disclosed solution for providing automatic discovery of application administrator to automatically discover an administrator(s) for a given application by processing logs (e.g., firewall logs) for an organization, which can then be applied to the onboarding of applications. For example, the model (104) can be used to recommend application administrators for more effective and efficient onboarding of the applications associated with the organization in data or posture security using the external service (e.g., for setting up and configuring the security service for the organization based on their applications/SaaS applications).

In some embodiments, the model can also be implemented to generate scores for each of the URLs and rank users visiting the URLs by frequency to determine top ranked users as candidates for the administrator user for the application associated with the organization.

In some embodiments, the model can also be implemented to analyze public API documentation using the ML model to predict whether an API URL is an administrator action URL (e.g., classifying APIs/URLs by admin actions as shown in the connector between model 104 and known URL builder 108 in FIG. 1).

In some embodiments, the disclosed solution for providing automatic discovery of application administrator to automatically discover an administrator(s) for a given application by processing logs (e.g., firewall logs) for an organization also includes monitoring for any changes and/or updates in API documentation and/or new trends in the logs (e.g., firewall logs) for ongoing model training.

In some embodiments, the disclosed solution for providing automatic discovery of application administrator to automatically discover an administrator(s) for a given application by processing logs (e.g., firewall logs) for an organization also includes identifying one or more SaaS application administrators for the organization (e.g., and instructing the SaaS application administrators to perform one or more actions to secure their SaaS application environment).

In some embodiments, the disclosed solution for providing automatic discovery of application administrator to automatically discover an administrator(s) for a given application by processing logs (e.g., firewall logs) for an organization also includes performing configuration changes associated with the application for enhanced security.

In some embodiments, the disclosed solution for providing automatic discovery of application administrator to automatically discover an administrator(s) for a given application by processing logs (e.g., firewall logs) for an organization also includes viewing distinct instances of the application and identifying respective administrators.

### Example Short Prompts for ChatGPT 4.0

Below are example short prompts for ChatGTP 4.0 for using an LLM-implemented model 104 as similarly described above with respect to FIG. 1.

The API documentation text example for the Slack API is available at https://api.slack.com/admins/workspaces.

Provide the following context to ChatGPT 4.0.
“Managing users in Enterprise Grid workspaces
The perfect workspace is like the perfect cup of coffee: a carefully-crafted container, filled to the brim with stimulating stuff.
Like a great cup of coffee, a workspace takes some time to craft: creating it, populating it with the right users, and setting admins and owners.
As the espresso machine revolutionized coffee, so too is there an express-track, programmatic way to construct workspaces: the APIs for managing users in a workspace.
All of the fine-tuned crafting of a perfect workspace, with none of the wasted time for admins. In an Enterprise Grid organization, your app can create a new workspace and get it running with the right users and admins, all in the time it takes a barista to pull a perfect shot of espresso.
Getting started
You'll need three scopes to allow your app to create workspaces and manage users:
admin.teams: write allows your app to create a workspace.
admin.teams: read allows your app to list owners or admins for a workspace.
admin.users: write allows your app to assign, invite, and remove users in a workspace. It also allows your app to designate a user as an admin, owner, or regular user.
All admin.* scopes are obtained using the normal OAuth flow, but there are a few extra requirements. The OAuth installation must be initiated by an Enterprise Grid admin or owner. Also, the install must take place on the Enterprise Grid org, not on an individual workspace using the workspace switcher during the install flow.
Installing the app on a workspace
Check out the scope documentation for more detail.
Creating a workspace
Craft your workspace at espresso speed with the admin.teams.create method.
Managing users in a workspace
A workspace starts out as a pristine porcelain container, empty and clean. But the real fun starts with conversation, and conversations need users.
Start off by inviting and assigning new or existing Grid users, respectively, into a workspace.
Inviting a user
Inviting a user is a polite first move. You'll invite users via email, just like you would using the Slack user invitation UI. The user doesn't have to be a member of your Grid organization yet.
Use the admin.users.invite method to invite a new user. You can specify channels that you'd like the user to join using the channel_ids parameter, and can also designate the user as a single-channel or multi-channel guest by using the is_restricted and is_ultra_restricted parameters respectively.
Assigning a user
Assign an existing Enterprise Grid user to a workspace if you want to skip the polite dance of invitation. If the user has previously been removed or left the workspace, they'll still be reinstated as a member.
Use the admin.users.assign method to assign a user to a workspace.
Again, you have the option to designate the user as a single-channel or multi-channel guest by using the is_restricted and is_ultra_restricted parameters respectively.
Removing a user
All good things must come to an end, even membership in the most memorable workspace. To remove a user, use the admin.users.remove method.
Designating a user as an admin, owner, or regular user
You can fine-tune the flavor of your workspace by designating users as an admin, owner or regular user. The user's current designation doesn't matter; all three methods can promote and demote users. Use the corresponding method to set a user to that specific user type:
Set a user as an admin with the admin.users.setAdmin method
Set a user as an owner with the admin.users.setOwner method
Set a user as a regular old user with the admin.users.setRegular method
Looking up admins, owners, and regular users
You can check which users are admins, workspace owners, and regular users by making use of three API methods, one for each type:
Return the list of workspace owners with the admin.teams.owners.list method
Return the list of admins with the admin.teams.admins.list method
Return the list of regular users with the admin.users.list method
Designating a user's role
Adding a role assignment to a user grants them the permission scopes that are assigned to that role. You can control role assignments with three methods:
Add a role assignment to a user with the admin.roles.addAssignments method
Remove a role assignment from a user with the admin.roles.removeAssignments method
See all existing role assignments in your organization with the admin.roles.listAssignments method.
Setting allowlists for private channels
Typically, any member of a private channel can invite anyone else belonging to their workspace into the channel.
However, you may need to restrict access to private channels due to sensitive or confidential information. The Private Channel Management APIs allow you to create a membership “allowlist” for both private, single-workspace channels and private cross-workspace shared channels.
These API methods may only be used for private channels, not for public channels or channels that are shared externally to different Grid organizations.
Add a private channel allowlist with the admin.conversations.restrictAccess.addGroup method
Remove a private channel allowlist with the admin.conversations.restrictAccess.removeGroup method
List private channel allowlists with the admin.conversations.restrictAccess.listGroups method
Here's a brief overview of what to expect when you create an allowlist for a private channel by linking an IDP group:
When a linked IDP group is added to a channel's allowlist:
If the added IDP group is the first group linked to this channel, any user who is not a member of that group is removed from the channel.
Members of the linked IDP group are not immediately added to the channel. They must be manually invited by a channel member.
Users who are not in one of the IDP groups linked to a channel cannot be invited to the channel.
Multiple IDP groups can be linked to a channel, but each API call must be made separately.
When a linked IDP group is removed from a channel's allowlist:
Members will be removed from the channel unless they remain on the channel allowlist through membership in another IDP group.
When a user is removed from an IDP group, they will be removed from any channels linked to that IDP group (unless they have access to the channel through membership in another IDP group).
If a channel is linked to a single group, the group must be disconnected from the channel before the group can be deleted.
If a channel is unlinked from all groups, it becomes a regular private channel-anyone can be invited.
If you send an SCIM request to remove over 1,000 users from a group that is linked to a channel, all in one request, the API call will fail.
Parting thoughts
Much like the beloved pour-over coffee, manually creating a workspace still makes for some great results. However, sometimes an Enterprise Grid Org Admin doesn't have time to make hundreds of cups of coffee, or hundreds of workspaces.
When time is pressing and the number of workspaces mounts, the APIs for creating workspaces and managing users can help. Combine with our other APIs for help in administering and managing workspaces to soothe the wounded souls of admins.”

Below are example queries based on this context.

Short prompts
“can you find URLs that identify admin action”
Creating a Workspace
admin.teams.create
Inviting a User
admin.users.invite
Assigning a User
admin.users.assign
Removing a User
admin.users.remove
Setting User Roles
admin.users.setAdmin
admin.users.setOwner
admin.users.setRegular
Listing Admins, Owners, and Regular Users
admin.teams.owners.list
admin.teams.admins.list
admin.users.list
Managing Role Assignments
admin.roles.addAssignments
admin.roles.removeAssignments
admin.roles.listAssignments
Managing Private Channels
admin.conversations.restrictAccess.addGroup
admin.conversations.restrictAccess.removeGroup
admin.conversations.restrictAccess.listGroups

These URLs correspond to API methods that facilitate various admin actions in an Enterprise Grid workspace.

As such, similar methods can be used to identify the API URLs for other applications as would now be apparent to one of ordinary skill in the art in view of the disclosed embodiments.

### Fine Tuning and Training of the Model

Below is a brief description of the fine tuning and training of the model, such as model 104 as shown in FIG. 1 as similarly described above.

In this example implementation, to fine-tune a model specifically for identifying admin action URLs in text, we design prompts that provide clear and relevant examples. These prompts should include sentences where admin action URLs are present and indicated as such. Below are a few examples of how we can structure these prompts.
Positive Examples (Admin Action URLs Indicated)
Creating a Workspace
Text: “You can create a workspace using the admin.teams.create method.”
Label: admin.teams.create
Inviting a User
Text: “To invite a new user, use the admin.users.invite API.”
Label: admin.users.invite
Assigning a User
Text: “Assign a user to a workspace with the admin.users.assign method.”
Label: admin.users.assign
Removing a User
Text: “Removing a user from a workspace can be done via the admin.users.remove API.”
Label: admin.users.remove
Setting User Roles
Text: “Set a user as an admin with the admin.users.setAdmin method.”
Label: admin.users.setAdmin
Text: “You can designate a user as an owner using the admin.users.setOwner method.”
Label: admin.users.setOwner
Text: “Use the admin.users.setRegular method to set a user as a regular user.”
Label: admin.users.setRegular
Listing Admins, Owners, and Regular Users
Text: “List all workspace owners with the admin.teams.owners.list API.”
Label: admin.teams.owners.list
Text: “Return the list of admins using the admin.teams.admins.list method.”
Label: admin.teams.admins.list
Text: “To get a list of regular users, use the admin.users.list method.”
Label: admin.users.list
Managing Role Assignments
Text: “Add a role assignment to a user with the admin.roles.addAssignments method.”
Label: admin.roles.addAssignments
Text: “Remove a role assignment using the admin.roles.removeAssignments method.”
Label: admin.roles.removeAssignments
Text: “See all existing role assignments with the admin.roles.listAssignments API.”
Label: admin.roles.listAssignments
Managing Private Channels
Text: “Add an allowlist for a private channel with the
admin.conversations.restrictAccess.addGroup method.”
Label: admin.conversations.restrictAccess.addGroup
Text: “Remove a private channel allowlist using the
admin.conversations.restrictAccess.removeGroup API.”
Label: admin.conversations.restrictAccess.removeGroup
Text: “List all private channel allowlists with the
admin.conversations.restrictAccess.listGroups method.”
Label: admin.conversations.restrictAccess.listGroups
Negative Examples (No Admin Action URLs)

To balance our training data, include negative examples where no admin action URLs are present. This helps the model learn to distinguish between sentences that contain admin action URLs and those that do not. Negative examples are provided below.
General Information
Text: “The perfect workspace is like the perfect cup of coffee.”
Label: None
General Instructions
Text: “You'll need three scopes to allow your app to create workspaces and manage users.”
Label: None

### Structuring the Dataset

Your dataset can be structured in a way that each example includes both the input text and the corresponding label, such as shown in the below JSON example code snippet.
[
   {
      “text”: “You can create a workspace using the admin.teams.create method.”,
      “label”: “admin.teams.create”
   },
   {
      “text”: “To invite a new user, use the admin.users.invite API.”,
      “label”: “admin.users.invite”
   },
   {
      “text”: “The perfect workspace is like the perfect cup of coffee.”,
      “label”: “None”
   }
]

### Training Process for Generating the Model

Below is a brief description of the training process for generating the model, such as model 104 as shown in FIG. 1 as similarly described above.

Tokenization: Tokenize the input text to convert it into a format suitable for the model.

Model Training: Use the Hugging Face transformers library to fine-tune the model with your dataset.

Evaluation: Continuously evaluate the model on a validation set to ensure it is learning to correctly identify admin action URLs.

### Example Code Snippet for Data Preparation and Training

Below is a basic example of how to structure the training data and fine-tune the model using the Hugging Face transformers library in the Python programming language.
from transformers import AutoTokenizer, AutoModelForSequenceClassification, Trainer, TrainingArguments
from datasets import Dataset
#Example dataset
data=[
   {“text”: “You can create a workspace using the admin.teams.create method.”, “label”: 1},
   {“text”: “To invite a new user, use the admin.users.invite API.”, “label”: 1},
   {“text”: “The perfect workspace is like the perfect cup of coffee.”, “label”: 0}
]
#Convert to Hugging Face Dataset
dataset=Dataset.from_pandas(pd.DataFrame(data))
#Load pre-trained model and tokenizer
model_name=“distilbert-base-uncased”
tokenizer=AutoTokenizer.from_pretrained(model_name)
model=AutoModelForSequenceClassification.from_pretrained(model_name, num_labels=2)
#Tokenize the dataset
def tokenize(batch):
   return tokenizer(batch[“text”], padding=True, truncation=True)
tokenized_dataset=dataset.map(tokenize, batched=True)
#Define training arguments
training_args=TrainingArguments(
   output_dir=“./results”,
   evaluation_strategy=“epoch”,
   learning_rate=2e-5,
   per_device_train_batch_size=16,
   per_device_eval_batch_size=16,
   num_train_epochs=3,
   weight_decay=0.01,
)
#Initialize Trainer
trainer=Trainer(
   model=model,
   args=training_args,
   train_dataset=tokenized_dataset,
   eval_dataset=tokenized_dataset,
   tokenizer=tokenizer,
)
#Train the model
trainer.train( )

By using these structured prompts and following this training process, we can fine-tune a model (e.g., model 104 as shown in FIG. 1) to effectively identify and extract admin action URLs from text.

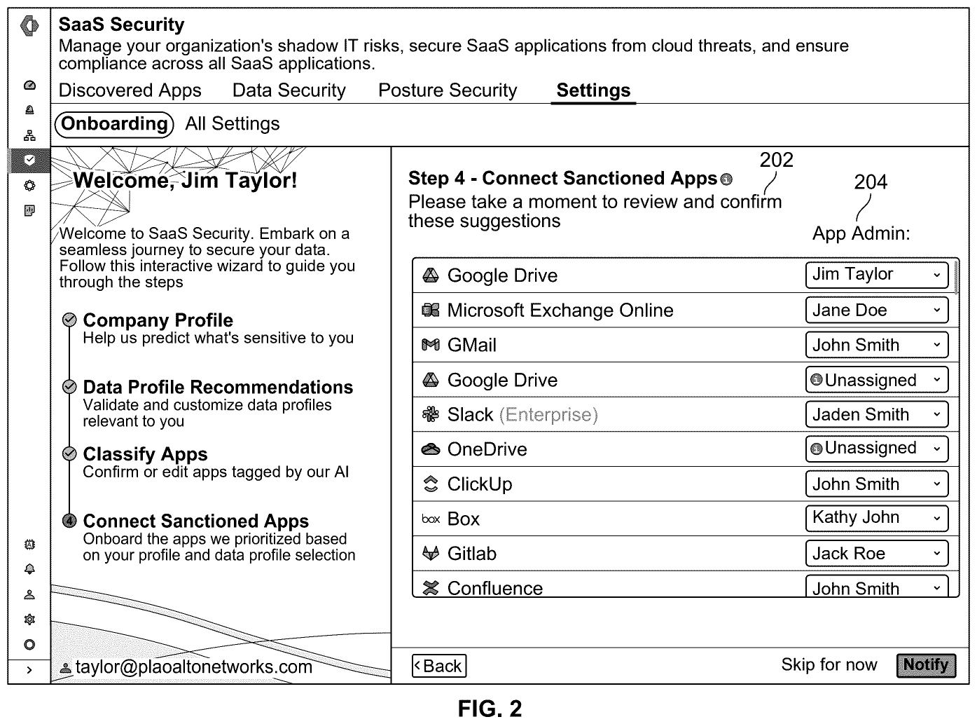

FIG. 2 illustrates a screen diagram of a system for providing the automatic discovery of an application administrator solution in accordance with some embodiments.

Specifically, FIG. 2 provides an example screen diagram of the disclosed solution for providing automatic discovery of application administrator to automatically discover an administrator(s) for a given application by processing logs (e.g., firewall logs) for an organization, such as similarly described above with respect to FIG. 1.

Referring to FIG. 2, the SaaS security screen includes a list of connected sanctioned apps as shown at 202 and their associated App Admin as shown at 204 that were determined as similarly described above with respect to FIG. 1.

As such, the disclosed solution for providing automatic discovery of application administrator can be used for automatic discovery of application administrators for a given application by looking through firewall logs for an organization.

Also, the disclosed solution for providing automatic discovery of application administrator can leverage the public API documentation such that the above-described model (104 as shown in FIG. 1) can effectively and efficiently predict whether the given API URL is an administrator action URL.

In addition, the disclosed solution for providing automatic discovery of application administrator creates admin recommendations for SaaS applications during the onboarding of SaaS security as similarly described above.

Moreover, the disclosed solution for providing automatic discovery of application administrator monitors for changes/updates in API documentation and new trends in firewall logs for continuous/ongoing training.

Finally, the disclosed solution for providing automatic discovery of application administrator can also automatically provide recommendations when there is a change/update in administrator of application.

Additional process embodiments and techniques for providing a privacy-aware dynamic path explainer will now be further described below.

### Example Process Embodiments for Providing Automatic Discovery of Application Administrator

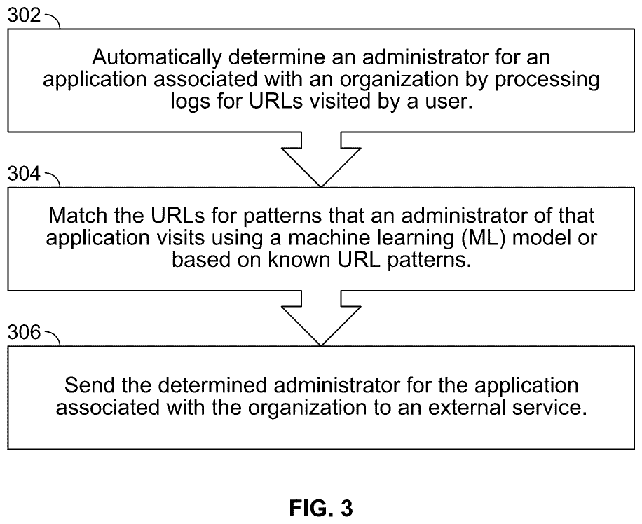

FIG. 3 is a flow diagram for a process for automatic discovery of application administrator in accordance with some embodiments. In some embodiments, a process as shown in FIG. 3 is performed by the system/service and techniques as similarly described above including the embodiments described above with respect to FIGS. 1 and 2.

At 302, automatically determining an administrator for an application (e.g., a Software as a Service (SaaS) application) associated with an organization by processing logs (e.g., firewall logs) for URLs visited by a user is performed. For example, the logs can include firewall logs, such as similarly described above.

At 304, matching the URLs for patterns that an administrator of that application visits using a machine learning (ML) model or based on known URL patterns is performed. For example, the ML model can include an ML-based classifier or a Large-Language Model (LLM), such as similarly described above. As another example, the known URL patterns can be matched using a regular expression (regex) pattern matcher, as also similarly described above.

At 306, sending the determined administrator for the application associated with the organization to an external service is performed. For example, the external service can include a security service, such as similarly described above.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
automatically determine an administrator for an application associated with an organization by processing logs for Uniform Resource Locators (URLs) visited by a user;
match the URLs for patterns that the administrator of that application visits using a machine learning (ML) model or based on known URL patterns; and
send the determined administrator for the application associated with the organization to an external service; and
a memory coupled to the processor and configured to provide the processor with instructions.

2. The system of claim 1, wherein the logs include one or more firewall logs.

3. The system of claim 1, wherein the application is a Software as a Service (Saas) application.

4. The system of claim 1, wherein a scheduler service is used to identify the known URL patterns based on public API documentation.

5. The system of claim 1, wherein a scheduler service is used to identify the known URL patterns based on public API documentation, and the known URL patterns are matched using a regular expression (regex) pattern matcher.

6. The system of claim 1, wherein the external service is a security service.

7. The system of claim 1, wherein the external service is a security service, and wherein the determined administrator for the application associated with the organization is sent to the security service for onboarding the application associated with the organization for security management.

8. The system of claim 1, wherein the ML model includes an ML-based classifier or a Large Language Model (LLM) for classifying the URLs as being associated with administrator activity for the application.

9. The system of claim 1, wherein the ML model includes a Large Language Model (LLM) for classifying the URLs as being associated with administrator activity for the application, and wherein the processor is further configured to:
generate one or more prompts for the LLM.

10. The system of claim 1, wherein the processor is further configured to:
generate scores for each of the URLs and rank users visiting the URLs by frequency to determine top ranked users as candidates for the administrator for the application associated with the organization.

11. A method, comprising:
automatically determining an administrator for an application associated with an organization by processing logs for Uniform Resource Locators (URLs) visited by a user;
matching the URLs for patterns that the administrator of that application visits using a machine learning (ML) model or based on known URL patterns; and
sending the determined administrator for the application associated with the organization to an external service.

12. The method of claim 11, wherein the logs include one or more firewall logs.

13. The method of claim 11, wherein the application is a Software as a Service (Saas) application.

14. The method of claim 11, wherein a scheduler service is used to identify the known URL patterns based on public API documentation.

15. The method of claim 11, wherein a scheduler service is used to identify the known URL patterns based on public API documentation, and the known URL patterns are matched using a regular expression (regex) pattern matcher.

16. The method of claim 11, wherein the external service is a security service.

17. The method of claim 11, wherein the external service is a security service, and wherein the determined administrator for the application associated with the organization is sent to the security service for onboarding the application associated with the organization for security management.

18. A computer program product embodied in a non-transitory computer readable medium and comprising computer instructions for:
automatically determining an administrator for an application associated with an organization by processing logs for Uniform Resource Locators (URLs) visited by a user;
matching the URLs for patterns that the administrator of that application visits using a machine learning (ML) model or based on known URL patterns; and
sending the determined administrator for the application associated with the organization to an external service.

19. The computer program product of claim 18, wherein the logs include one or more firewall logs.

20. The computer program product of claim 18, wherein the application is a Software as a Service (SaaS) application.
